(19) United States
(12) Patent Application Publication
(10) Pub. No.: US 2016/0096578 A1
(43) Pub. Date: Apr. 7, 2016

(54) SCOOTER

(71) Applicant: SHUN-WEN LIU, TAOYUAN (TW)

(72) Inventor: JEEN-NENG FAN, TAOYUAN (TW)

(21) Appl. No.: 14/606,195

(22) Filed: Jan. 27, 2015

(30) Foreign Application Priority Data
Oct. 1, 2014 (TW) 103217419

(51) Int. Cl. B62K 21/02; B62K 9/02; B62K 9/00

(52) U.S. Cl. CPC B62K 21/02; B62K 9/00; B62K 9/02

(57) ABSTRACT

A scooter includes a footrest, a front tube installed at the front of the footrest, a rider riser pivotally connected to the front tube, a handle installed at the top of the rider riser, a front wheel installed at the bottom of the rider riser, and a rear wheel installed at the rear of the footrest. The front wheel is installed at the bottom of the rider riser and biasedly disposed on a side of the front tube. A rider stands on the footrest and operates the handle and scooter by hands and body to swing the front wheel sideway to produce an S-shaped movement pattern and drive the scooter. Such bias design with a turning point of the rider riser provides biased component forces to the handle and scooter body separately to move the scooter forward and improve the force applying efficiency, variability and fun of the scooter.

### FIELD OF THE INVENTION

The present invention relates to a scooter, and more particularly to the scooter with the features of simple structure, easy and convenient operation, high speed, high efficiency and rich variability and fun.

### BACKGROUND OF THE INVENTION

With reference to FIGS. 1 and 2 for a conventional scooter, the conventional scooter comprises a footrest 1 provided for a rider to stand thereon, a front tube 2 installed at the front end of the footrest 1 through a connecting base 21, a rider riser 3 pivotally connected to the front tube 2, a handle 4 installed at the top end of the rider riser 3, a front wheel 5 installed at the bottom end of the rider riser 3, and a rear wheel 6 installed at the rear end of the footrest 1. Wherein, the rider riser 3 uses the front tube 2 as a pivot for a free rotating motion, and the front wheel 5, the front tube 2 and the rear wheel 6 are installed linearly. During the use of the scooter, a rider stands on the footrest 1 by one leg, and steps on the ground by the other leg, while swinging the handle 4 to the left and right sides for a turning operation. The front wheel 5 will be swung sideway to produce an S-shaped movement pattern for moving forward or making a turn. In the meantime, the rear wheel 6 may assist the balance of the forward movement to achieve a smooth sliding effect.

However, the trend in consumer purchasing of scooters has gradually cooled down after these years, and thus it is an urgent and important subject for related manufacturers to design and develop innovative scooters in order to attract consumers and improve their willingness to buy.

### SUMMARY OF THE INVENTION

It is a primary objective of the present invention to provide a scooter with the features of high efficiency, high traveling speed, and rich variability and fun.

To achieve the aforementioned objective, the present invention provides a scooter comprising a footrest, a front tube installed at a front end of the footrest, a rider riser pivotally coupled to the front tube, a handle installed at a top end of the rider riser, a front wheel installed at a bottom end of the rider riser, and a rear wheel installed at a rear end of the footrest, characterized in that the front wheel- is installed at a bottom end of the rider riser and biasedly disposed on a side of the front tube, so that a rider may stand on the footrest and operate the handle and scooter by the rider's hands and body to swing the front wheel sideway in order to produce an S-shaped movement pattern and drive the scooter. Such bias design with a turning point of the rider riser provides biased component forces to the handle and scooter body separately to move the scooter forward and improve the force applying efficiency, variability and fun of the scooter.

### BRIEF DESCRIPTION OF THE DRAWINGS

FIG. 1 is a perspective view of a conventional scooter;

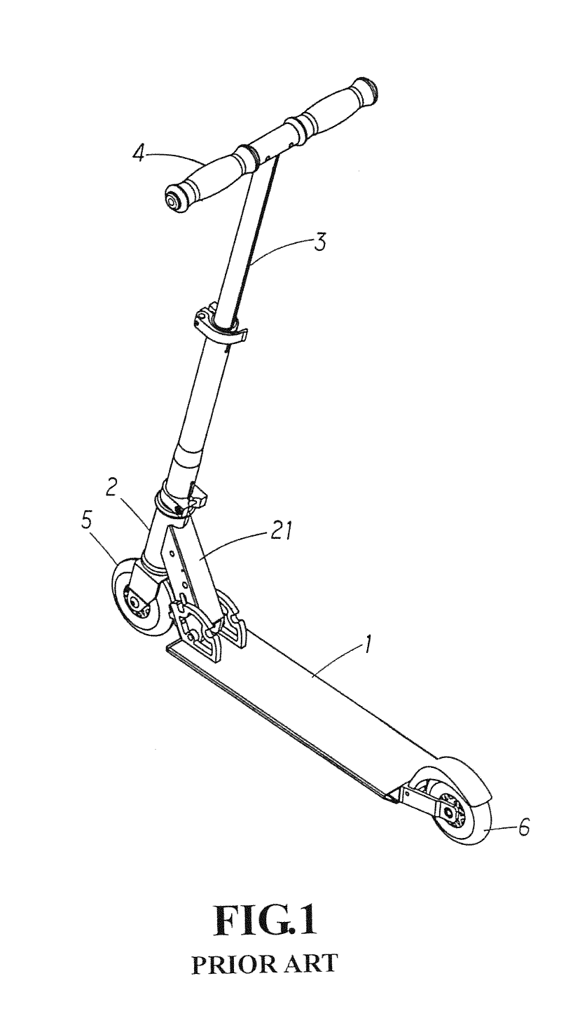

FIG. 2 is a bottom view of FIG. 1;

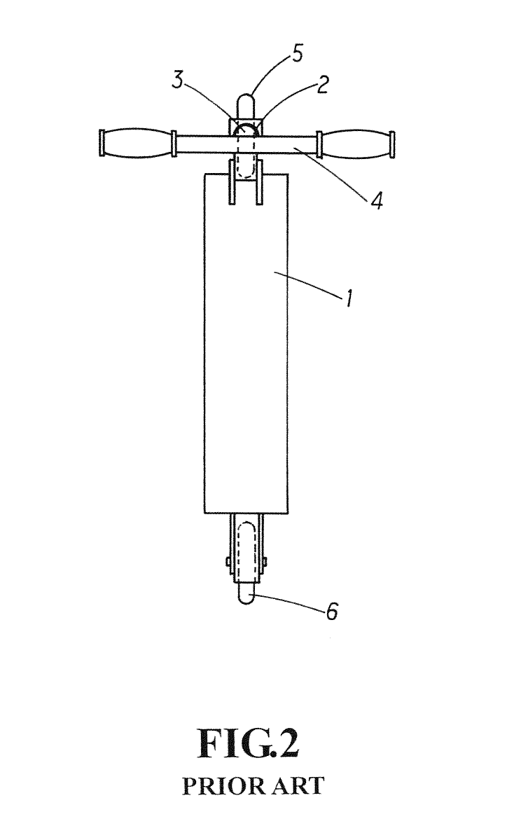

FIG. 3 is a perspective view of a scooter in accordance with a first preferred embodiment of the present invention;

FIG. 4 is a bottom view of FIG. 3;

FIG. 5 is a perspective view of a scooter in accordance with a second preferred embodiment of the present invention;

FIG. 6 is a perspective view of a scooter in accordance with a third preferred embodiment of the present invention;

FIG. 7 is a perspective view of a scooter in accordance with a fourth preferred embodiment of the present invention;

FIG. 8 is a perspective view of a scooter in accordance with a fifth preferred embodiment of the present invention;

FIG. 9 is a perspective view of a scooter in accordance with a sixth preferred embodiment of the present invention; and

FIG. 10 is a perspective view of a scooter in accordance with a seventh preferred embodiment of the present invention.

### DESCRIPTION OF REPRESENTATIVE NUMERALS

h: Height difference; 1: Footrest; 2: Front tube; 3: Rider riser; 4: Handle; 5: Front wheel; 6: Rear wheel; 7: Second front wheel; 10: Flexible carrier rod; 11: Footrest; 12: Fixed rear wheel; 13: Fixed carrier rod; 14: Footrest; 15: Swingable rear wheel; 16: Movable carrier rod; 17: Footrest; 18: Swingable rear wheel.

### DESCRIPTION OF THE PREFERRED EMBODIMENTS

The technical characteristics, contents, advantages and effects of the present invention will be apparent with the detailed description of a preferred embodiment accompanied with related drawings as follows.

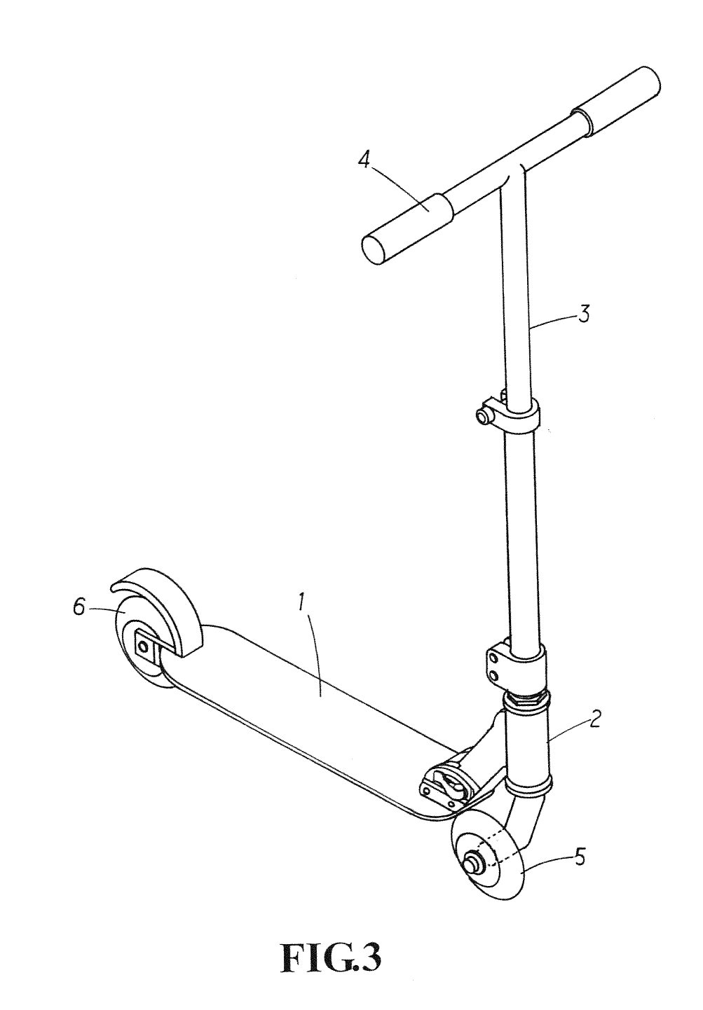

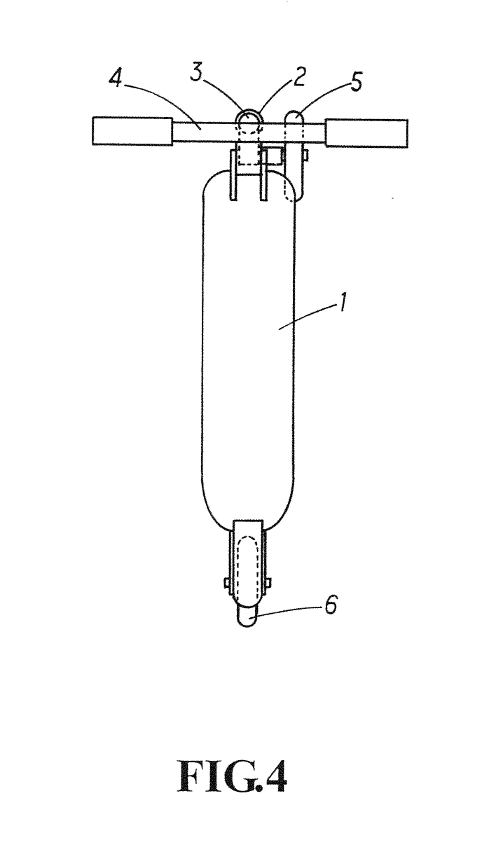

With reference to FIGS. 3 and 4 for a scooter of the present invention, the scooter comprises: a footrest 1 provided for a rider to stand thereon; a front tube 2, coupled to a front end of the footrest 1; a rider riser 3, pivotally coupled to the front tube 2, and the front tube 2 may be used as a turning point for free rotations; a handle 4, installed at a top end of the rider riser 3 and provided for the rider to hold, operate, and turn the rider riser 3 by both ends; a front wheel 5, installed at a bottom end of the rider riser 3, and provided for changing moving directions according to the rotation of the rider riser 3; and a rear wheel 6, installed at a rear end of the footrest 1 and capable of assisting a balanced movement of the scooter, characterized in that the front wheel 5 is installed at a bottom end of the rider riser 3 and biasedly disposed on a side of the front tube 2.

The aforementioned front wheel 5 is biasedly disposed on a side at the bottom end of the front tube 2 is arranged nonlinearly with the front tube 2 and the rear wheel 6 to form a triangular shape.

In the aforementioned structure of the scooter of the present invention, the rider riser 3 uses the front tube 2 as a turning point, and the front wheel 5 in contact with the ground is installed at the lower end of the rider riser 3 and then biasedly disposed on a side of the front tube 2, and being used together with the rear wheel 6 in contact with the ground as a turning point of the front tube 2 to form a nonlinear triangular shape, and when the rider holds the handle 4 by both hands and stands on the footrest 1 by a leg to operate the scooter, the whole scooter body uses the front tube 2 as a reference to produce a relatively greater tilt force in a biased direction opposite to the front wheel 5 (In other words, if the front wheel 5 is biasedly installed on the right side of the front tube 2, then the scooter body will produce a left tilt force). To maintain a balanced and smooth movement of the scooter body, the rider has to apply a force to the scooter body and the handle 4 by the rider's both hands and body in order to resist the tilt force, and the rider keeps swinging the handle 4 to the left and right sides repeatedly for a turning operation according to the traveling speed and direction. The front wheel 5 installed at the bottom end of the rider riser 3 and biasedly disposed on a side of the front tube 2 is swung and turned together with the handle 4, and such arrangement not just produces a sideway bias swinging and an S-shaped movement pattern to drive the scooter body to move forward only, but also directly receives component forces coming from lateral sides due to the biased design when the handle 4 and the scooter body are swung sideway, and keeps pushing and rolling the scooter by the lateral component forces, so as to achieve a high force applying efficiency and improve the moving speed.

In other words, the present invention arranges the front wheel 5 to be installed at the bottom end of the rider riser 3 and biasedly disposed on a side of the front tube, such that the front wheel 5, the front tube 2, and the rear wheel 6 are arranged nonlinearly into a triangular shape. When the rider holds the handle 4 by both hands and stands on the footrest 1 by a leg to operate the scooter to move forward, the biasedly installed front wheel 5 is rolled in an S-shaped movement pattern as the rider applies left and right swinging forces to the scooter body and the handle 4 by the body and both hands. In particular, when the scooter body and the handle 4 are swung sideway to left and right sides, the scooter is rolled forward by lateral component forces. Such arrangement not just improves the force applying efficiency for operating the scooter only, but also increases the moving speed of the scooter. The operation and the force applying mode of the scooter may be changed to achieve the effect of enhancing the variability and fun of the scooter.

In other words, the present invention arranges the front wheel 5 installed at the bottom end of the rider riser 3 and biasedly disposed on a side of the front tube 2 and the front wheel 5, the front tube 2 and the rear wheel 6 are arranged nonlinearly into a triangular shape. Compared with the operation mode and effect of the front wheel installed at the bottom end of the rider riser of the conventional scooter and linearly arranged with the front tube and the rear wheel, the present invention is obviously different and has outstanding variability and attractiveness. When a rider operates the conventional scooter and applies a force to swing the scooter body and handle by the rider's hands and body, the conventional front wheel may receive a portion of non-vertical lateral component forces. Since the front wheel is almost situated right below the front tube and arranged linearly with the front tube and the rear wheel, therefore the generated and received lateral component forces are naturally smaller and less significant, and the operating mode, efficiency and speed of the scooter are limited (In other words, although a portion of the front wheel of the conventional scooter is situated below the bottom end of the front tube or slightly to the front or rear side, and when the scooter is moving forward, a portion of non-vertical lateral component forces is received, the front wheel regardless of being situated precisely below the front tube or below the front tube and at a position slightly towards the front or the rear is aligned linearly with the front tube and the rear wheel, and thus lateral left and right components forces will not be generated automatically. Therefore, when the scooter is moved forward by being swung sideway, the lateral component forces generated and received by the front wheel are naturally smaller). On the contrary, the present invention arranges the front wheel 5 in stalled at the bottom end of the rider riser 3 and biasedly disposed on a side of the front tube 2, and the front wheel 5 is arranged linearly with the front tube 2 and the rear wheel 6 into, a triangular shape. When the rider swings the scooter body and the handle 4 sideway to left and right sides by both hands and body, the lateral component forces automatically generated and received by the front wheel 5 are relatively greater, so as to improve the force applying efficiency and sliding speed of the scooter. In addition, the present invention provides various operating and force applying modes to improve the variability, fun and attractiveness of the scooter.

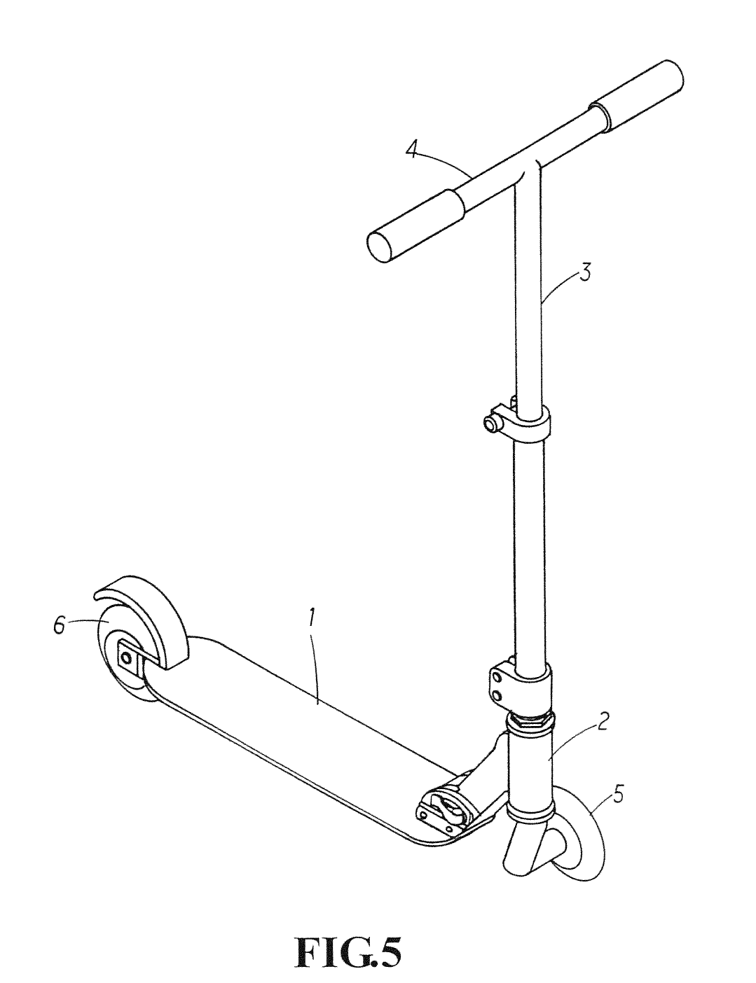

In FIG. 5, the front wheel 5 of the present invention is installed at the bottom end of the rider riser 3 or biasedly installed to the left or right side of the front tube 2, and the front wheel 5, the front tube 2 and the rear wheel 6 are arranged nonlinearly into a triangular shape, so that a left-handed or right-handed rider may operate the scooter easily and safely.

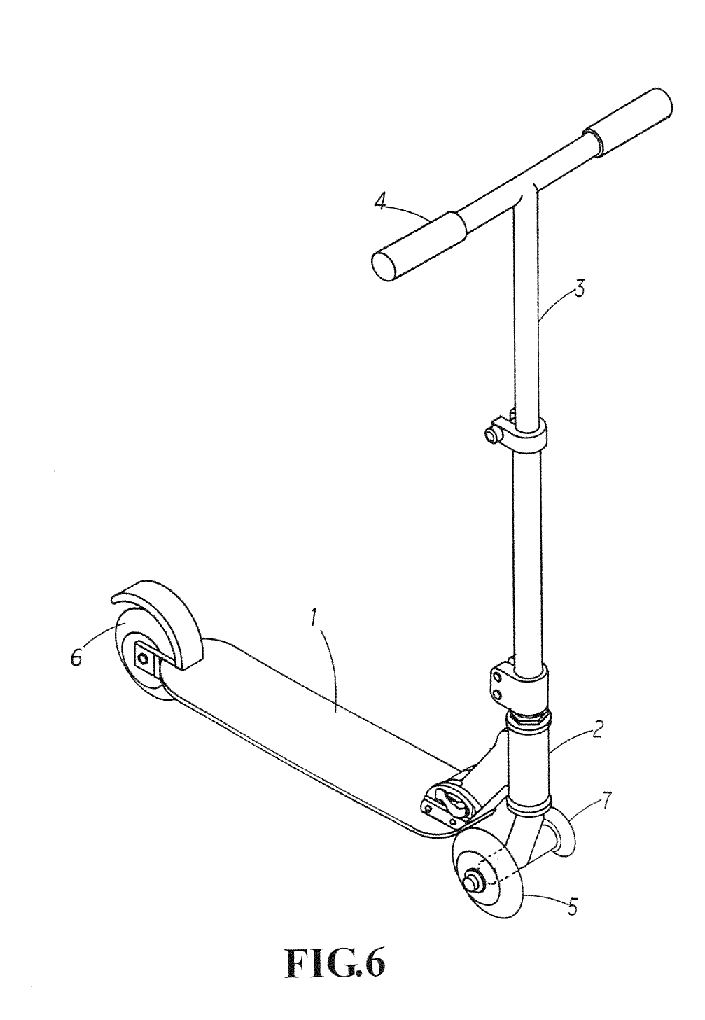

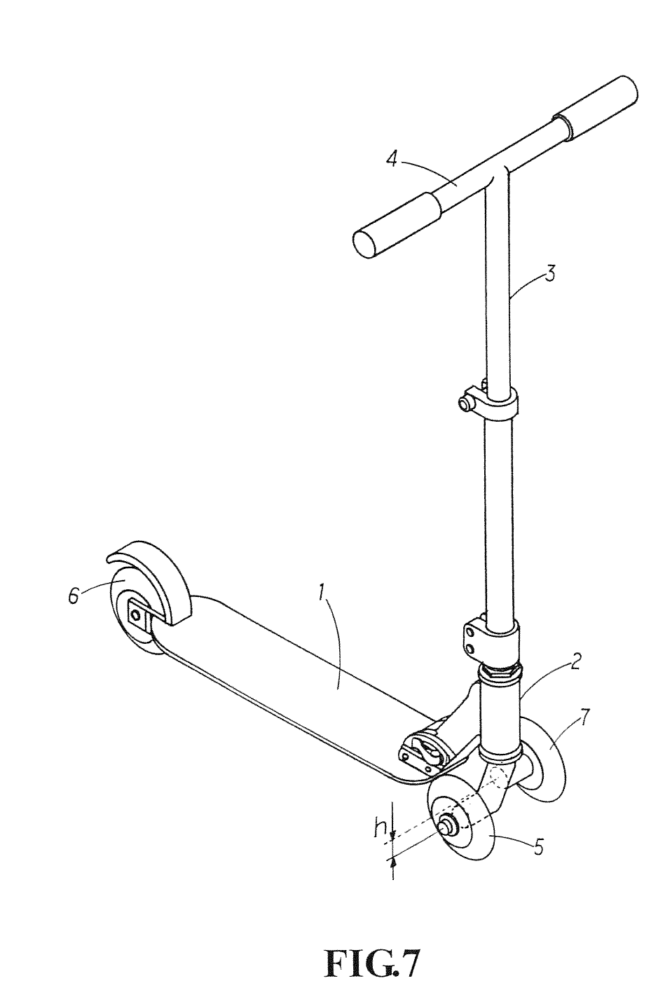

In FIGS. 6 and 7, the present invention arranges the front wheel 5 installed at the bottom end of the rider riser 3 and biasedly disposed on a side of the front tube 2, and the front wheel 5, the front tube 2 and the rear wheel 6 are arranged nonlinearly into a triangular shape, and at least one second front wheel 7 is installed at an opposite side of the front wheel 5 of the bottom end of the rider riser 3, and the second front wheel 7 the second front wheel 7 and the front wheel 5 are in contact with the ground slantingly on different horizontal planes, such that when the scooter is operated to make a turn, the second front wheel 7 provides the support effect to assist the movement of the scooter body. To maintain the front wheel 5 and the second front wheel 7 to be in contact with the ground at different horizontal planes, the second front wheel 7 has a diameter smaller than the diameter of the front wheel 5 (as shown in FIG. 6), or the second front wheel 7 has a diameter greater than or equal to the diameter of the front wheel 5 (as shown in FIG. 7). However, the axes of the second front wheel 7 and the front wheel 5 must have an appropriate height difference h.

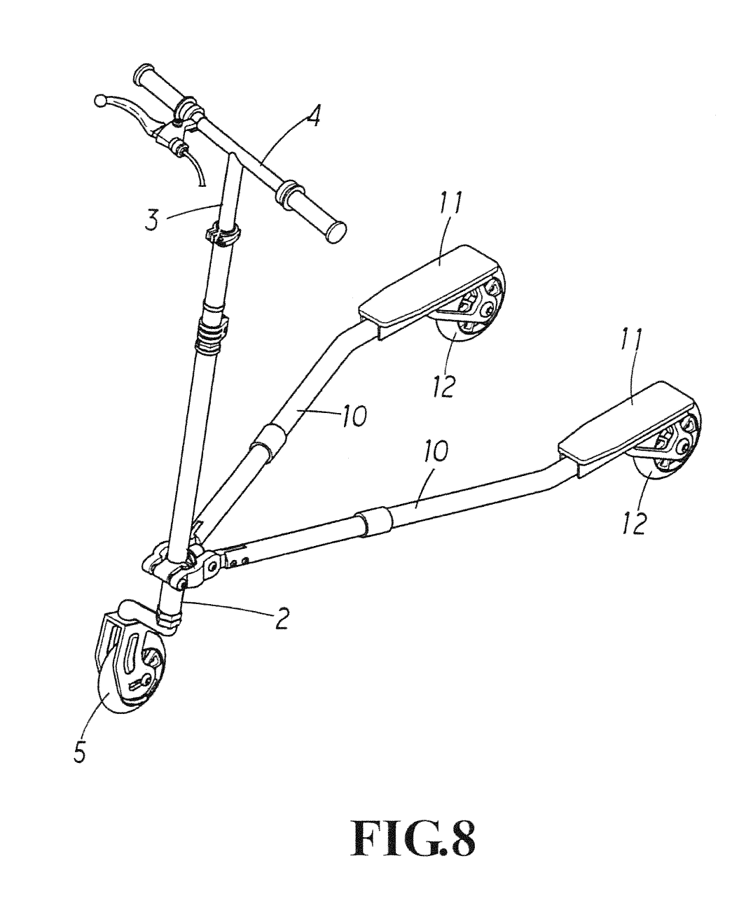

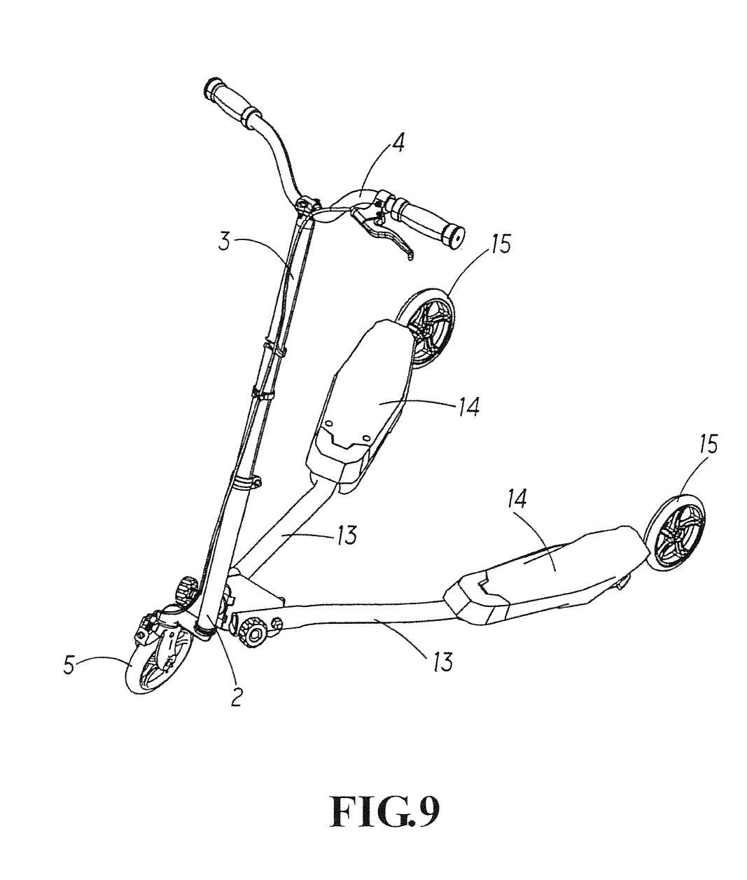

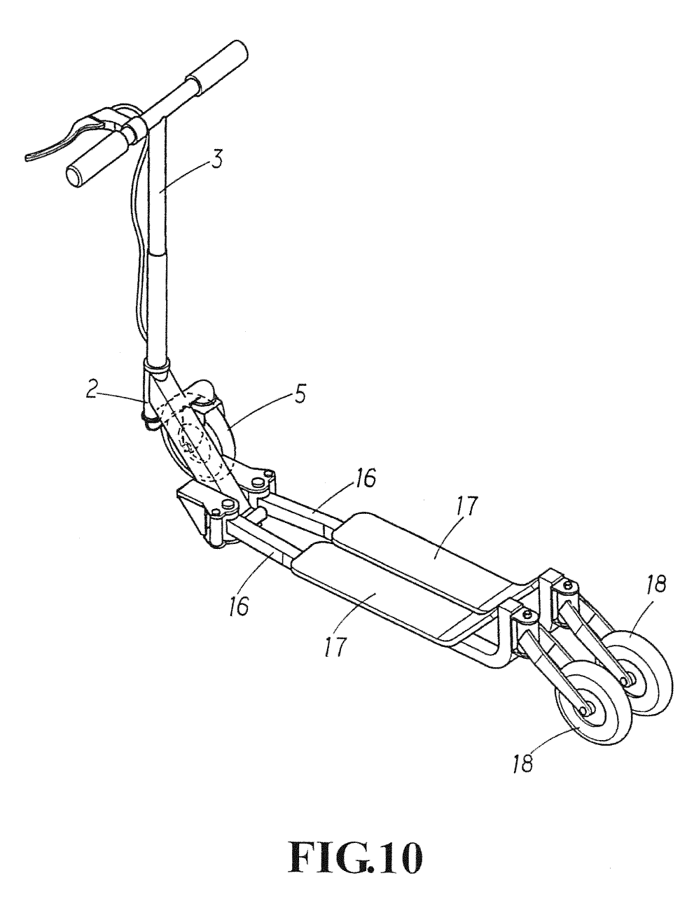

In FIGS. 8 to 10, the present invention arranges the front wheel 5 biasedly installed to a three-wheel scooter. In FIG. 8. the front wheel 5 installed at the bottom end of the rider riser 3 is biasedly disposed on a side of the front tube 2 and applied to a three-wheel scooper having left and flexible carrier rods 10, left and right footrests 11 and left and right fixed rear wheels 12. In FIG. 9, the front wheel 5 installed at the bottom end of the rider riser 3 is biasedly disposed on a side of the front tube 2 and applied to a three-wheel scooter having left and right fixed carrier rods 13, left and right footrests 14 and left and right swingable rear wheels 15. In FIG. 10, the front wheel 5 installed at the bottom end of the rider riser 3 is biasedly disposed on a side of the front tube 2 and applied to a three-wheel scooter having left and right movable carrier rods 16, left and right footrests 17 and left and right swingable rear wheels 18. Since the front wheel 5 of various different three-wheel scooters is installed at the bottom end of the rider riser 3 and biasedly disposed on a side of the front tube 2, and the front wheel 5, two fixed rear wheels 12 or swingable rear wheels 15, 18 are arranged in a way to provide different operating and force applying modes of the three-wheel scooters, such that the three-wheel scooters have high force applying efficiency and moving speed, so as to provide better variability, fun and attractiveness of the scooter.

To meet the requirement of the aforementioned scooters, the front wheel 5 is installed at the bottom end of the rider riser 3 and biasedly disposed right below the front tube 2 or below a position toward the front or the rear.

In summation of the description above, the present invention has the following advantages and effects:

1. Simple and economic structure;

2. High force applying efficiency and improved moving speed; and

3. Changeable operation and force applying modes of the scooter to improve the variability, fun and attractiveness of the scooter.

1. A scooter, comprising:
a footrest;
a front tube, installed at a front end of the footrest;
a rear wheel, installed at a rear end of the footrest, the rear wheel disposed in longitudinal linear alignment with the front tube and the footrest;
a rider riser, pivotally coupled to the front tube;
a handle, installed at a top end of the rider riser;
a front wheel, installed at a bottom end of the rider riser and biasedly disposed at the bottom of the front tube and transversely linearly offset from the footrest, the front tube and the rear wheel.

2. The scooter of claim 1, wherein the front wheel is biasedly disposed at the bottom end of the front tube and transversely linearly offset from the longitudinally linearly aligned front tube and the rear wheel, the front wheel, front tube and rear wheel thereby forming a triangular shape.

3. The scooter of claim 1, wherein the front wheel installed at the bottom end of the rider riser is biasedly disposed on any one of the left and right sides of the front tube.

4. The scooter of claim 1, wherein the front wheel is installed at the bottom end of the rider riser and biasedly disposed on a side of the front tube, and at least one second front wheel is installed on a side opposite to the front wheel, and the second front wheel and the front wheel are slantingly contacted with the ground and at positions of different horizontal planes respectively.

5. The scooter of claim 4, wherein the second front wheel is smaller than the front wheel.

6. The scooter of claim 4, wherein the second front wheel has a diameter greater than or equal to the diameter of the front wheel.

7. The scooter of claim 6, wherein the second front wheel and the front wheel have axes with a height difference.

8. The scooter of claim 1, wherein the front wheel installed at the bottom end of the rider riser is biasedly disposed right below a side of the front tube, or below the front or the rear of a side of the front tube.

9. The scooter of claim 1, wherein one or more of the front wheels are installed at the bottom end of the rider riser and biasedly disposed on a side of the front tube.

10. The scooter of claim 1, wherein the front wheel is installed at the bottom end of the rider riser of a three-wheel scooter and biasedly disposed on a side of the front tube.
